(19) United States
(12) Patent Application Publication
(10) Pub. No.: US 2012/0331346 A1
(43) Pub. Date: Dec. 27, 2012

(54) TEST APPARATUS AND TEST METHOD

(75) Inventor: Hiromi OSHIMA, Gunma (JP)

(73) Assignee: ADVANTEST CORPORATION, Tokyo (JP)

(21) Appl. No.: 13/445,929

(22) Filed: Apr. 13, 2012

(30) Foreign Application Priority Data
Jun. 27, 2011 (JP) 2011-141898

(51) Int. Cl. G06F 11/28

(52) U.S. Cl. 714/32; 714/E11.178

(57) ABSTRACT

A test apparatus that tests a device under test outputting a data signal and a clock signal indicating a timing at which the data signal is to be sampled, the test apparatus comprising a buffer section that buffers the data signal; a pattern generating section that, for each test period of the test apparatus, generates a control signal and an expected value of the data signal; a reading control section that, for each test period, reads the data signal from the buffer section on a condition that the control signal instructs the reading control section to read data from the buffer section; and a judging section that compares the data signal read by the reading control section to the expected value generated by the pattern generating section.

### BACKGROUND

1. Technical Field

The present invention relates to a test apparatus and a test method.

2. Related Art

An interface is known that is referred to as “source-synchronous,” in which a clock signal is output in synchronization with a data signal. Patent Document 1 describes a test apparatus that tests a device under test adopting such an interface. The test apparatus in Patent Document 1 samples the data value of a data signal using a clock signal output from the device under test, and compares the sampled data value to an expected value.
Patent Document 1: U.S. Pat. No. 7,644,324
Patent Document 2: Japanese Patent Application Publication No. 2002-222591
Patent Document 3: U.S. Pat. No. 6,556,492

When testing a device under test that adopts such an interface, the sampled data values are read and compared to the expected value after being temporarily stored in a buffer. However, if the timing at which a data value is read from the buffer is too early, the test apparatus performs the reading process before the sample data value is stored in the buffer, and therefore accurate testing cannot be achieved. Furthermore, if the timing at which the data value is read form the buffer is too late, the buffer can overflow, and in this case as well the test apparatus cannot achieve accurate testing. Accordingly, the test apparatus must read an appropriate number of pieces of data from the buffer at the appropriate timing.

### SUMMARY

Therefore, it is an object of an aspect of the innovations herein to provide a test apparatus and a test method, which are capable of overcoming the above drawbacks accompanying the related art. The above and other objects can be achieved by combinations described in the independent claims. According to a first aspect related to the innovations herein, provided is a test apparatus that tests a device under test outputting a data signal and a clock signal indicating a timing at which the data signal is to be sampled, the test apparatus comprising a buffer section that buffers the data signal; a pattern generating section that, for each test period of the test apparatus, generates a control signal and an expected value of the data signal; a reading control section that, for each test period, reads the data signal from the buffer section on a condition that the control signal instructs the reading control section to read data from the buffer section; and a judging section that compares the data signal read by the reading control section to the expected value generated by the pattern generating section. Also provided is a test method performed using the test apparatus.

The summary clause does not necessarily describe all necessary features of the embodiments of the present invention. The present invention may also be a sub-combination of the features described above.

### BRIEF DESCRIPTION OF THE DRAWINGS

FIG. 1 shows a device under test 200 and a test apparatus 10 that tests the device under test 200, according to an embodiment of the present invention.

FIG. 2 shows timings of a data signal and clock signal output from the device under test 200.

FIG. 3 shows a configuration of the test apparatus 10 according to the present embodiment.

FIG. 4 shows exemplary configurations of the clock generating section 36 and a data acquiring section 38.

FIG. 5 shows exemplary timings of a data signal, a clock signal, a delay signal, a first strobe signal, a second strobe signal, and a sampling clock.

FIG. 6 shows a timing chart of a case in which a function test is performed on a device under test 200 that is a memory device.

FIG. 7 shows examples of a command and read enable signal transmitted from the test apparatus 10 to the device under test 200, a clock signal and data signal transmitted from the device under test 200 to the test apparatus 10, timing of a mask signal and a sampling clock, and timing of data transmitted from the buffer section 58 to the judging section 42.

FIG. 8 shows examples of test instructions, control signals, test patterns, and expected value patterns stored in the pattern memory 23.

FIG. 9 shows an exemplary read flag and comparison flag when the data value of the data signal DQ is acquired at the timing of the clock signal DQS.

FIG. 10 shows an exemplary read flag and comparison flag when the data value of the data signal DQ is acquired at the timing of the timing signal generated within the test apparatus 10.

FIG. 11 shows a configuration of a test apparatus 10 according to a modification of the present embodiment.

FIG. 12 shows exemplary timings of a data signal DQ, clock signal DQS, read flag, comparison flag, and address comparison.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

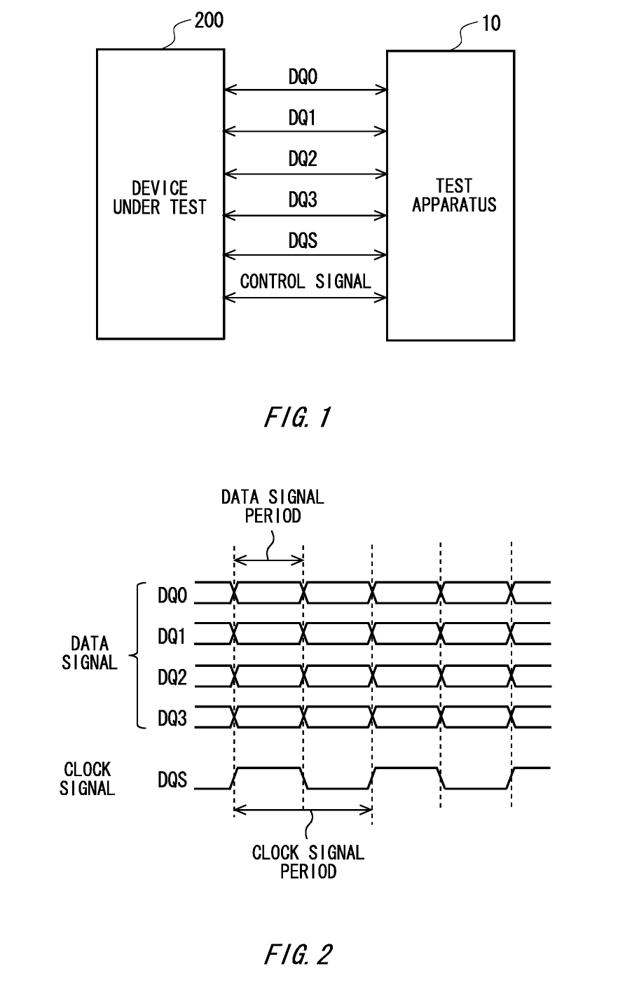

FIG. 1 shows a device under test 200 and a test apparatus 10 that tests the device under test 200, according to an embodiment of the present invention. FIG. 2 shows timings of a data signal and clock signal output from the device under test 200.

The test apparatus 10 according to the present embodiment tests the device under test 200. In the present embodiment, the device under test 200 exchanges data with another device via a DDR (Double Data Rate) interface, which is a bidirectional bus.

The DDR interface transmits a plurality of data signals DQ and a clock signal DQS, which indicates the timing at which the data signals DQ are sampled, in parallel. In the present example, as shown in FIG. 2, the DDR interface transmits one clock signal DQS for four data signals DQ0, DQ1, DQ2, and DQ3. Furthermore, the DDR interface transmits the data signals DQ at a rate that is twice the rate of the clock signal DQS and synchronized with the clock signal DQS.

In the present embodiment, the device under test 200 is a non-volatile memory device, for example, and writes and reads data to and from another control device via the DDR interface. The test apparatus 10 of the present embodiment tests the device under test 200 by exchanging the data signals DQ and clock signal DQS with the device under test 200 via the DDR interface, which is a bidirectional bus. Furthermore, the test apparatus 10 exchanges control signals, such as write enable signals and read enable signals, with the device under test 200.

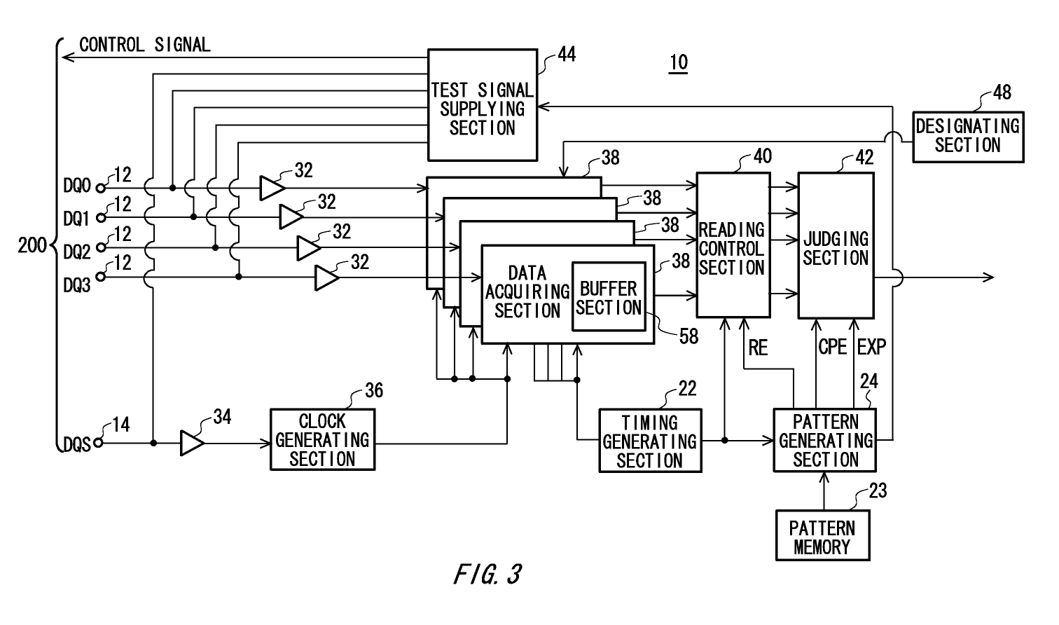

FIG. 3 shows a configuration of the test apparatus 10 according to the present embodiment. The test apparatus 10 includes a plurality of data terminals 12, a clock terminal 14, a timing generating section 22, a pattern memory 23, a pattern generating section 24, a plurality of data comparators 32, a clock comparator 34, a clock generating section 36, a plurality of data acquiring sections 38, a reading control section 40, a judging section 42, a test signal supplying section 44, and a designating section 48.

Each data terminal 12 is connected to an input/output terminal for a data signal in the device under test 200, via the DDR interface that is a bidirectional bus. In this example, the test apparatus 10 includes four data terminals 12. The four data terminals 12 are connected respectively to the input/output terminals for the four data signals DQ0, DQ1, DQ2, and DQ3 of the device under test 200, via the DDR interface. The clock terminal 14 is connected to an input/output terminal for the clock signal DQS of the device under test 200, via the DDR interface.

The timing generating section 22 generates a timing signal corresponding to the test period of the test apparatus 10, based on a reference clock generated within the test apparatus 10. The timing generating section 22 may generate a timing signal synchronized with the test period, for example.

The pattern memory 23 stores an instruction sequence of test instructions to be executed by the pattern generating section 24 in respective test periods. Furthermore, the pattern memory 23 stores a test pattern and expected value pattern corresponding to each test instruction. The expected value pattern represents an expected value of the data signal to be transmitted form the device under test 200. The test pattern represents a waveform of a signal to be transmitted to the device under test 200 from the test apparatus 10.

The pattern memory 23 stores control data for controlling the operation of the test apparatus 10, in correspondence with each of the test instructions. The control data includes a read flag indicating whether a data signal is to be read from the buffer section 58 in a data acquiring section 38 and a comparison flag indicating whether the judging section 42 is to compare the data signal to the expected value, for example.

The pattern generating section 24 sequentially executes the test instructions included in the instruction sequence stored in the pattern memory 23, in the respective test periods. For each test period, the pattern generating section 24 generates an expected value pattern and a test pattern associated with the test instruction to be executed. The pattern generating section 24 supplies the test signal supplying section 44 with the generated test pattern. The pattern generating section 24 supplies the judging section 42 with the generated expected value pattern.

For each test period, the pattern generating section 24 generates a control signal for controlling each component in the test apparatus 10, according to the control data associated with the test instruction to be executed. For example, the pattern generating section 24 may generate, as the control signal for each test period, the read flag indicating whether a data signal is to be read from the buffer section 58 and the comparison flag indicating whether the judging section 42 is to compare the data signal to the expected value. The pattern generating section 24 supplies the generated control signal to the corresponding block. The pattern generating section 24 may supply the read flag to the reading control section 40 and the comparison flag to the judging section 42, for example.

The data comparators 32 are provided to correspond respectively to the data signals exchanged with the device under test 200 via the DDR interface. In the present example, the test apparatus 10 includes four data comparators 32 corresponding respectively to the four data signals DQ0, DQ1, DQ2, and DQ3. Each data comparator 32 receives the corresponding data signal output from the device under test 200, via the corresponding data terminal 12. Each data comparator 32 compares the received data signal to a predetermined threshold level to convert the data signal into a logic value, and outputs the data signal as a logic value.

The clock comparator 34 is provided to correspond to the clock signal DQS exchanged with the device under test 200 via the DDR interface. The clock comparator 34 receives the corresponding clock signal output from the device under test 200 via the corresponding clock terminal 14. The clock comparator 34 compares the received clock signal to a predetermined threshold level to convert the clock signal into a logic value, and outputs the clock signal as a logic value.

The clock generating section 36 generates a sampling clock for sampling the data signals output from the device under test 200, based on the clock signal expressed as a logic value from the clock comparator 34. In this example, the clock generating section 36 generates a sampling clock having a rate that is twice that of the clock signal.

The data acquiring sections 38 are provided to correspond respectively to the data signals output by the device under test 200 via the DDR interface. In this example, the test apparatus 10 includes four data acquiring sections 38 corresponding respectively to the four data signals DQ0, DQ1, DQ2, and DQ3.

The data acquiring sections 38 acquire the data signals output by the device under test 200 at a timing of the sampling clock corresponding to the clock signal, or at a timing of the timing signal corresponding to the test period of the test apparatus 10. In the present embodiment, each data acquiring section 38 acquires the data value of the corresponding data signal at the timing of the sampling clock generated by the clock generating section 36, or at the timing of the timing signal generated by the timing generating section 22. The data acquiring sections 38 switch between acquiring the data signals at the timing of the sampling clock or at the timing of the timing signal, according to a designation by the designating section 48.

Each data acquiring section 38 includes a buffer section 58. The buffer section 58 buffers the acquired data signal.

The reading control section 40 reads the data signal buffered in the buffer section 58 of each data acquiring section 38, at a timing of the timing signal generated by the timing generating section 22. The reading control section 40 supplies the read data signals to the judging section 42. In this case, for each test period, the reading control section 40 reads the data signal in each buffer section 58 on a condition that the read flag instructs reading of the data signal.

The judging section 42 compares the data signals read by the reading control section 40 to the expected value generated by the pattern generating section. In this case, for each test period, the judging section 42 compares the data signal read by the reading control section 40 to the expected value on a condition that the comparison flag instructs a comparison between the data signal and the expected value. The judging section 42 judges pass/fail of the device under test 200 based on the results of the comparisons between the data signals and the expected value.

The test signal supplying section 44 supplies the test signal to the device under test 200 according to the test pattern generated by the pattern generating section 24. In the present embodiment, the test signal supplying section 44 outputs a plurality of data signals as the test signal to the device under test 200, via the DDR interface that is a bidirectional bus, and a clock signal indicating the sampling timing of the output data signals to the device under test 200 via the DDR interface. In other words, the test signal supplying section 44 outputs the data signals DQ0, DQ1, DQ2, and DQ3 to the device under test 200 via the data terminals 12, and outputs the clock signal DQS to the device under test 200 via the clock terminal 14.

Furthermore, the test signal supplying section 44 supplies the device under test 200 with a read enable signal that permits data output, as a control signal. As a result, the test signal supplying section 44 can cause the data signals DQ including data stored in the device under test 200 to be output from the device under test 200 via the DDR interface.

The designating section 48 designates whether the data acquiring sections 38 acquire the data signals at a timing corresponding to the clock signal, or at a timing of the timing signal corresponding to the test period. For example, the designating section 48 may designate whether the data acquiring sections 38 acquire the data signals at a timing corresponding to the clock signal or at a timing of the timing signal corresponding to the test period, according to execution of a test program. When the designating section 48 designates that the data signals are to be acquired at the timing of the clock signal, the buffer sections 58 acquire the data signals at a timing corresponding to the clock signal. When the designating section 48 designates that the data signals are to be acquired at the timing of the timing signal, the buffer sections 58 acquire the data signals at a timing corresponding to the timing signal.

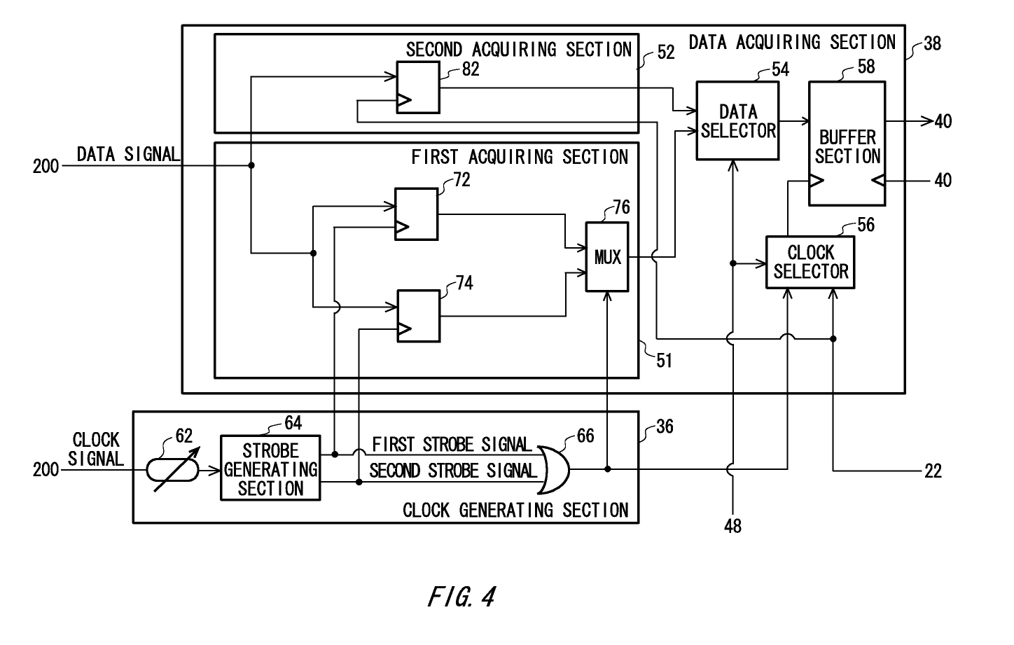

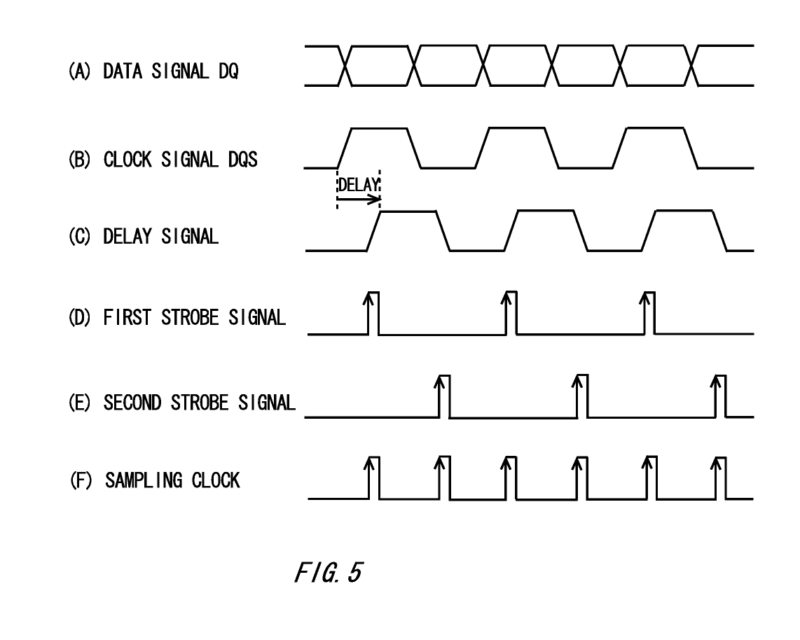

FIG. 4 shows exemplary configurations of the clock generating section 36 and a data acquiring section 38. FIG. 5 shows exemplary timings of a data signal, a clock signal, a delay signal, a first strobe signal, a second strobe signal, and a sampling clock.

The data acquiring section 38 inputs a data signal including a data value to be transmitted at a predetermined data rate, as shown by (A) in FIG. 5. The data acquiring section 38 sequentially samples the data value included in the data signal DQ, at the timing of the sampling clock generated by the clock generating section 36.

The clock generating section 36 includes a delay device 62, a strobe generating section 64, and a combining section 66, for example. The delay device 62 receives from the device under test 200 a clock signal DQS with a rate that is twice that of the data signal DQ, such as shown by (B) in FIG. 5. The delay device 62 outputs a delay signal obtained by temporally delaying the received clock signal DQS by ¼ the period of the clock signal DQS, such as shown by (C) in FIG. 5.

The strobe generating section 64 generates a first strobe signal having a pulse with a very small time width at the rising edge of the delay signal, such as shown by (D) in FIG. 5. In this way, the clock generating section 36 can output the first strobe indicating the timing at which the odd-numbered data values of the data signal DQ are to be sampled.

The strobe generating section 64 generates a second strobe signal having a pulse with a very small time width at the falling edge of the delay signal, such as shown by (E) in FIG. 5. In this way, the clock generating section 36 can output the second strobe indicating the timing at which the even-numbered data values of the data signal DQ are to be sampled. Instead, the first strobe signal may indicate the timings at which the even-numbered data values of the data signal DQ are to be sampled and the second strobe signal may indicate the timings at which the odd-numbered data values of the data signal DQ are to be sampled.

The combining section 66 outputs a sampling clock obtained by combining the first strobe signal and the second strobe signal, as shown by (F) in FIG. 5. For example, the combining section 66 outputs a sampling clock obtained by calculating the OR of the first strobe signal and the second strobe signal. In this way, the combining section 66 can output a sampling clock indicating a timing that is substantially in the center of the eye opening between data values included in the data signal DQ.

The data acquiring section 38 includes a first acquiring section 51, a second acquiring section 52, a data selector 54, a clock selector 56, and a buffer section 58. The first acquiring section 51 acquires the data value of the data signal DQ shown in (A) of FIG. 5, at the timing of the sampling clock shown in (F) of FIG. 5. The first acquiring section 51 includes an odd-number flip-flop 72, an even-number flip-flop 74, and a multiplexer 76, for example.

The odd-number flip-flop 72 acquires the data value of the data signal DQ output from the device under test 200, at the timing of the first strobe signal, and holds these data values therein. The even-number flip-flop 74 acquires the data value of the data signal DQ output from the device under test 200, at the timing of the second strobe signal, and holds these data values therein.

The multiplexer 76 selects the data values of the data signal DQ held in the odd-number flip-flop 72 and the data values of the data signal DQ held in the even-number flip-flop 74 alternately at the timing of the sampling clock, and supplies the selected values to the buffer section 58 via the data selector 54. In this way, the first acquiring section 51 can acquire the data value of the data signal DQ at the timing corresponding to the sampling clock generated by the clock generating section 36.

The second acquiring section 52 acquires the logic value of the data signal DQ shown by (A) in FIG. 5, at a timing corresponding to the timing signal generated by the timing generating section 22. The rate of the timing signal generated by the timing generating section 22 may be higher than the rates of the clock signal DQS and the data signal DQ output from the device under test 200, for example. In this case, the second acquiring section 52 can acquire a data sequence representing a waveform of the data signal DQ.

The second acquiring section 52 includes at least one flip-flop 82, for example. The flip-flop 82 acquires the data value of the data signal DQ at a timing of the timing signal generated by the timing generating section 22.

The data selector 54 selects either the data value acquired by the first acquiring section 51 or the data value acquired by the second acquiring section 52, according to the designation by the designating section 48, and supplies the buffer section 58 with the selected data value. When the designating section 48 designates that the data signal is to be acquired at a timing corresponding to the sampling clock, the data selector 54 transmits the data value output from the first acquiring section 51 to the buffer section 58. When the designating section 48 designates that the data signal is to be acquired at a timing corresponding to the timing signal, the data selector 54 transmits the data value output from the second acquiring section 52 to the buffer section 58.

The clock selector 56 selects one of the sampling clock generated by the clock generating section 36 and the timing signal generated by the timing generating section 22, according to the designation by the designating section 48, and supplies the buffer section 58 with the selected signal. When the designating section 48 designates that the data signal is to be acquired at a timing corresponding to the sampling clock, the clock selector 56 supplies the buffer section 58 with the sampling clock generated by the clock generating section 36. When the designating section 48 designates that the data signal is to be acquired at a timing corresponding to the timing signal, the clock selector 56 supplies the buffer section 58 with the timing signal generated by the timing generating section 22.

The buffer section 58 includes a plurality of entries. The buffer section 58 buffers the data values transmitted from the data selector 54 sequentially in the plurality of entries, according to the timing of the signal output from the clock selector 56.

In other words, when the designating section 48 designates that the data signal DQ is to be acquired at a timing corresponding to the sampling clock, the buffer section 58 buffers the data values of the data signal DQ output by the multiplexer 76 of the first acquiring section 51 sequentially in the entries thereof, at a timing of the sampling clock generated by the clock generating section 36. When the designating section 48 designates that the data signal DQ is to be acquired at a timing corresponding to the timing signal, the buffer section 58 buffers the data values of the data signal DQ output by the second acquiring section 52 sequentially in the entries thereof, at a timing of the timing signal generated by the timing generating section 22.

Furthermore, the buffer section 58 outputs the data values DQ of the data signal DQ buffered in the entries thereof, in the order in which the data values were input, at the timing of a read control signal provided from the reading control section 40. The buffer section 58 supplies the reading control section 40 with the output data values of the data signal DQ.

The clock generating section 36 and the data acquiring section 38 described above can acquire the data signal DQ output from the device under test 200 at either a timing corresponding to the clock signal DQS or a timing corresponding to the timing signal generated within the test apparatus 10, and store the acquired data signal in the buffer section 58. When the data signal DQ output from the device under test 200 is acquired at a timing corresponding to the clock signal DQS, the clock generating section 36 and the data acquiring section 38 can then switch the timing to output the data values of the acquired data signal DQ at a timing corresponding to the timing signal generated based on the internal clock of the test apparatus 10.

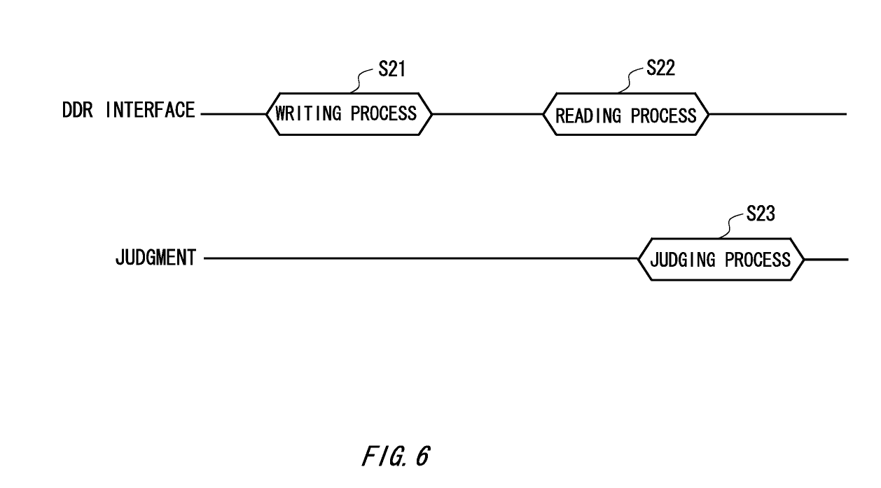

FIG. 6 shows a timing chart of a case in which a function test is performed on a device under test 200 that is a memory device. The device under test 200 is a memory device that exchanges data with another device via a DDR interface, which is a bidirectional bus. When testing a device under test 200 that is a memory device, the test apparatus 10 operates in the following manner.

First, at step S21, the test apparatus 10 writes predetermined data to the address region to be tested in the device under test 200. Next, at step S22, the test apparatus 10 reads the data written to the address region to be tested in the device under test 200. At step S23, which is performed in parallel with step S22, the test apparatus 10 compares the read data to the expected value and judges whether the address region under test in the device under test 200 is operating correctly. The test apparatus 10 can judge pass/fail of the device under test 200 by performing such a process on all of the address regions in the device under test 200.

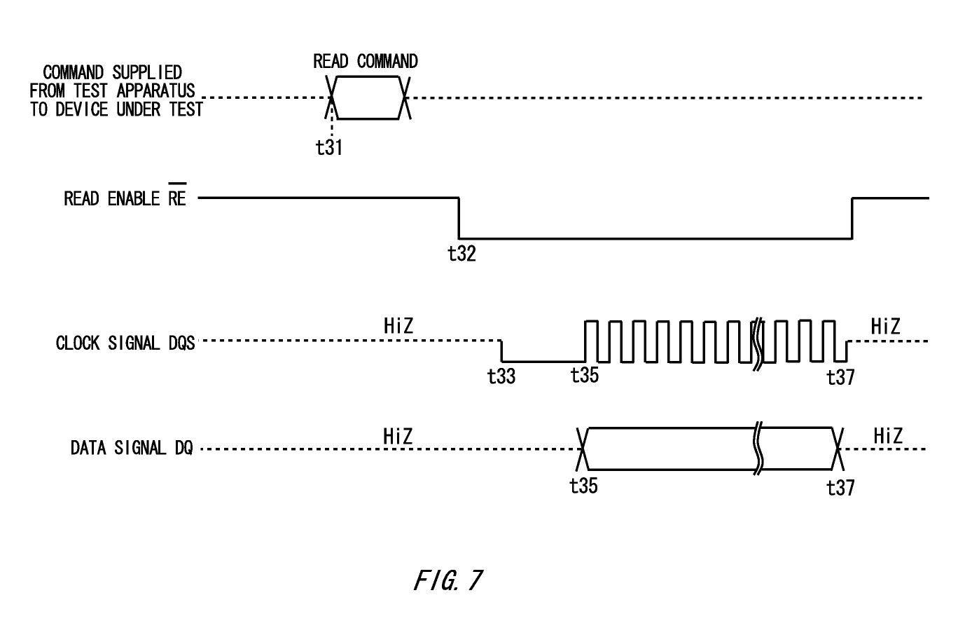

FIG. 7 shows examples of a command and read enable signal transmitted from the test apparatus 10 to the device under test 200, a clock signal and data signal transmitted from the device under test 200 to the test apparatus 10, timing of a mask signal and a sampling clock, and timing of data transmitted from the buffer section 58 to the judging section 42. When reading data from a device under test 200 that is a memory device via the DDR interface, the test apparatus 10 performs the following operations.

First, the test signal supplying section 44 of the test apparatus 10 outputs, to the device under test 200 via the DDR interface, the clock signal and data signal indicating the command, e.g. read command, instructing the device under test 200 to output a data signal (time t31). Next, the test signal supplying section 44 supplies the device under test 200 with the read enable signal permitting data output (time t32).

Next, the device under test 200 provided with the read command outputs the data signal DQ including the data value stored at the address indicated by the read command, via the DDR interface, after a prescribed time has passed from when the read command was provided (time t35). Along with this, the device under test 200 outputs the clock signal DQS indicating the sampling timing of the data signal DQ, via the DDR interface (time t35). When the a prescribed number of pieces of data of the data signal DQ has been output, the device under test 200 ends the output of the data signal DQ and the clock signal DQS (time t37).

The device under test 200 has high impedance (HiZ) and does not drive the input/output terminal of the data signal DQ, at all times other than the output time period of the data signal DQ (time t35 to time t37). Furthermore, the device under test 200 fixes the clock signal DQS at a predetermined level, e.g. low logic level, for a prescribed time period (time t33 to time t35) prior to the output time period of the data signal DQ (time t35 to time t37). Furthermore, the device under test 200 has high impedance (HiZ) and does not drive the input/output terminal of the clock signal DQS before the period during which the clock signal DQS is fixed at a predetermined signal level (before time t33) and after the output period of the data signal DQ (time t37).

The data acquiring section 38 of the test apparatus 10 sequentially acquires the data value of the data signal DQ at the timing of the clock signal DQS output from the device under test 200, during a period (time t35 to time t37) in which the device under test 200 outputs the data signal. The data acquiring section 38 sequentially buffers the acquired data in the entries thereof. In the manner described above, during the reading process, the test apparatus 10 can read the data signal DQ from the device under test 200 that is a memory device via the DDR interface, and acquire the data value of the data signal DQ at the timing of the clock signal DQS.

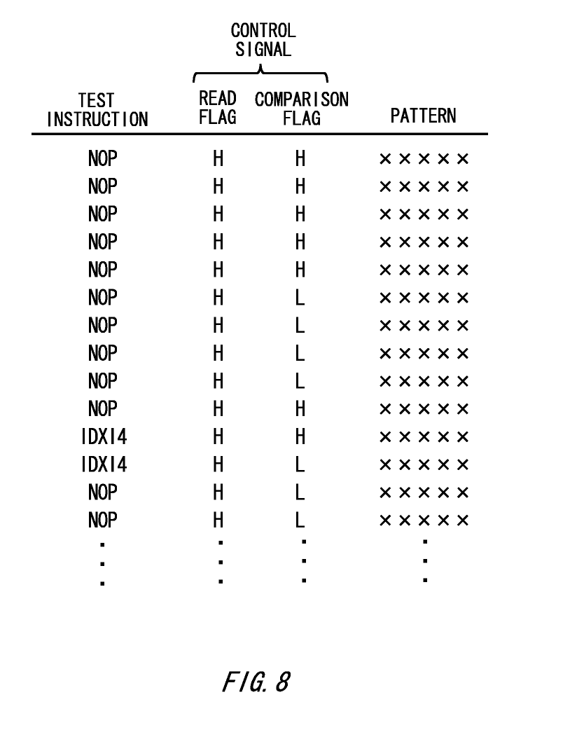

FIG. 8 shows examples of test instructions, control signals, test patterns, and expected value patterns stored in the pattern memory 23. The pattern memory 23 stores an instruction sequence of test instructions to be executed by the pattern generating section 24. The instruction sequence includes test instructions such as NOP instructions and branching instructions (IDXI instructions), for example.

The pattern memory 23 stores patterns, e.g. test patterns and expected value patterns, corresponding respectively to the test instructions included in the instruction sequence. Furthermore, the pattern memory 23 stores control signals, e.g. read flags and comparison flags, in association with each of the test instructions included in the instruction sequence.

The pattern generating section 24 is a sequencer, for example, and executes one test instruction for each test period. For each test period, the pattern generating section 24 outputs patterns, e.g. a test pattern and an expected value pattern, corresponding to the executed test instruction, and control signals, e.g. a read flag and a comparison flag, corresponding to the executed test instruction. In this way, the pattern generating section 24 can output the read flags and the comparison flags at a predetermined timing.

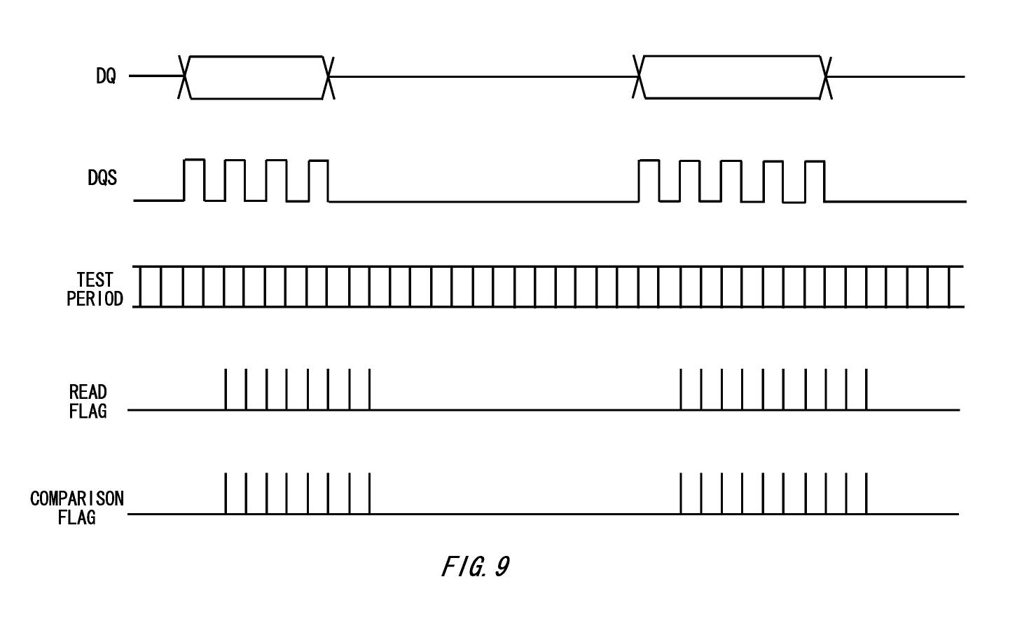

FIG. 9 shows an exemplary read flag and comparison flag when the data value of the data signal DQ is acquired at the timing of the clock signal DQS. When the data value of the data signal DQ is acquired at the timing of the clock signal DQS, the device under test 200 writes an amount of data equal to the number of pieces of data generated by the device under test 200 to the buffer section 58. Therefore, when the reading control section 40 reads an amount of data that is greater than the number of pieces of data generated by the device under test 200 from the buffer section 58, the buffer section 58 experiences an underflow. When the reading control section 40 reads an amount of data that is less than the number of pieces of data generated by the device under test 200 from the buffer section 58, the buffer section 58 experiences an overflow.

Accordingly, when data value of the data signal DQ is acquired at the timing of the clock signal DQS, the pattern generating section 24 generates a number of read flags and comparison flags that is equal to the number of pieces of data output from the device under test 200. In this way, the reading control section 40 can read all of the data written in the buffer section 58, without causing an underflow or an overflow.

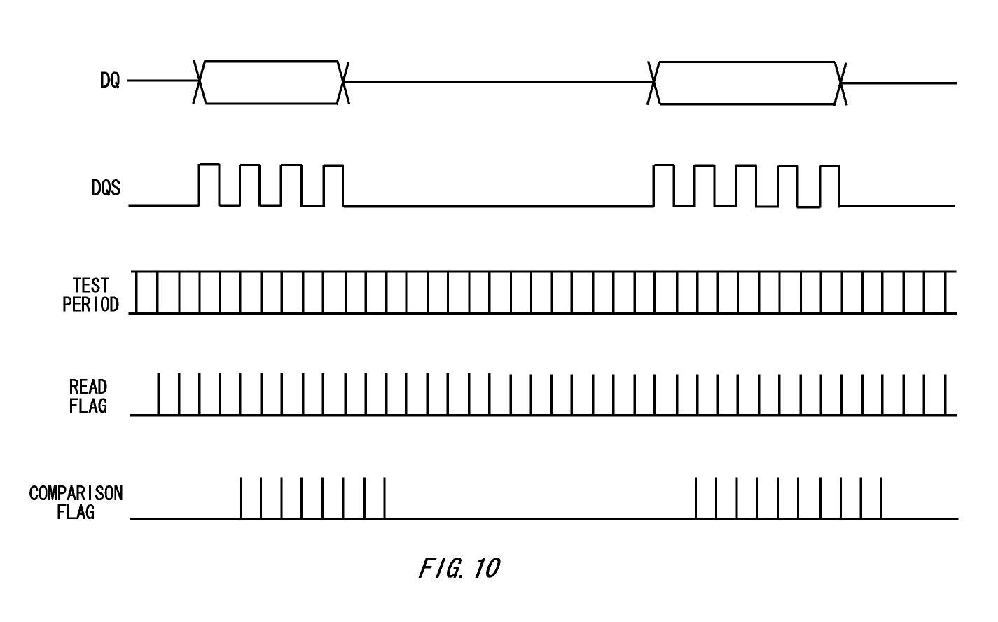

FIG. 10 shows an exemplary read flag and comparison flag when the data value of the data signal DQ is acquired at the timing of the timing signal generated within the test apparatus 10. When the data value of the data signal DQ is acquired at the timing of the timing signal, data is written to the buffer section 58 in each test period. Therefore, the reading control section 40 must read the data in every test period, and this causes an underflow in the buffer section 58.

Accordingly, when the data value of the data signal DQ is acquired at the timing of the timing signal, the pattern generating section 24 generates a number of read flags that is equal to the number of times the timing signal is generated. In this way, the reading control section 40 can read all of the data written in the buffer section 58, without causing an underflow or an overflow.

However, only the data acquired at the timing of the clock signal DQS, from among the pieces of data written to the buffer section 58, is valid, and all other data is invalid. Therefore, the judging section 42 must compare only the valid data to the expected value. Accordingly, when the data value of the data signal is acquired at the timing of the timing signal, the pattern generating section 24 generates a comparison flag at the timing at which the valid data output from the device under test 200 is generated. In this way, the judging section 42 can compare the valid data output from the device under test 200 to the expected value.

In the manner described above, the test apparatus 10 can use the test instructions to independently control the timing at which the data is read from the buffer section 58 and the timing at which the read data is compared to the expected value. In this way, the test apparatus 10 can read a suitable amount of data from the buffer section 58 in a case where the data is acquired at the timing of the clock signal DQS output from the device under test 200 and in a case where the data is acquired at the timing of the timing signal generated within the test apparatus 10.

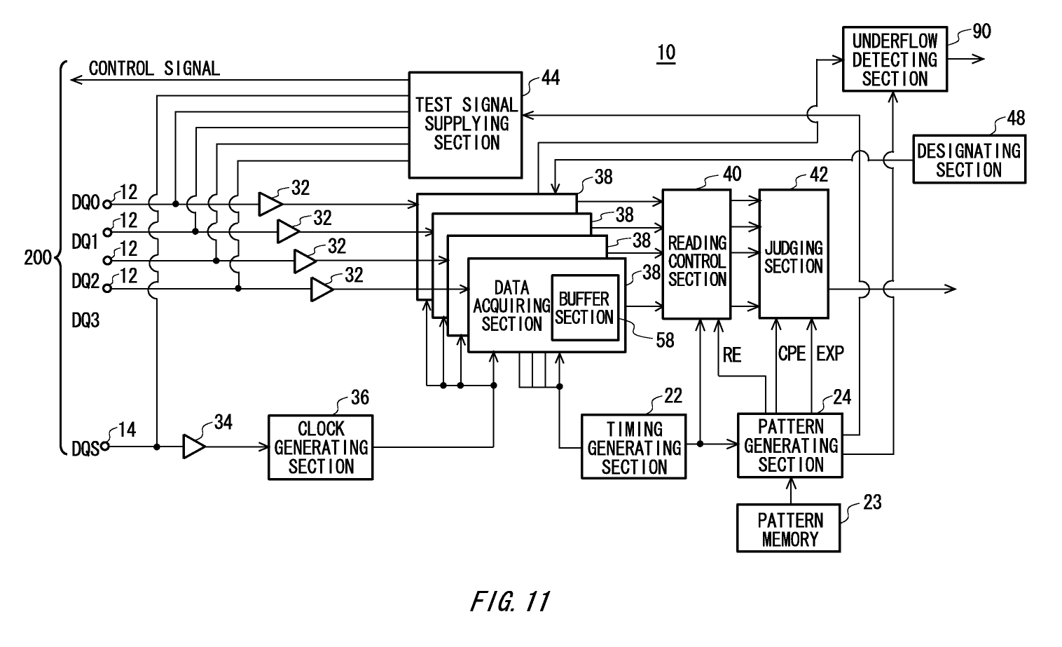

FIG. 11 shows a configuration of a test apparatus 10 according to a modification of the present embodiment. The test apparatus 10 of the present modification adopts substantially the same function and configuration as the test apparatus 10 according to the embodiment shown in FIG. 3, and therefore components that have substantially the same function and configuration as those shown in FIG. 3 are given the same reference numerals and redundant descriptions are omitted.

The test apparatus 10 of the present modification further includes an underflow detecting section 90. The underflow detecting section 90 detects whether an underflow occurs in the buffer sections 58 of the plurality of data acquiring sections 38. In other words, the underflow detecting section 90 detects when the reading control section 40 reads in a manner such that the reading position of the data signal from the buffer section 58 is ahead of the writing position of the data signal in the buffer section 58.

For example, when the device under test 200 is not operating correctly, there are cases where the expected amount of data is not output from the device under test 200. In such a case, regardless of the fact that the expected amount of data has not been written to the buffer section 58, the expected amount of data is read, and therefore the buffer section 58 experiences an underflow and correct testing cannot be achieved. By including the underflow detecting section 90, the test apparatus 10 can detect when such an underflow has occurred in the buffer section 58, and can therefore stop testing on a condition that an underflow occurs in the buffer section 58. As a result, the test apparatus 10 can stop testing of a device under test 200 that is not operating correctly midway through the testing, and can therefore perform testing efficiently.

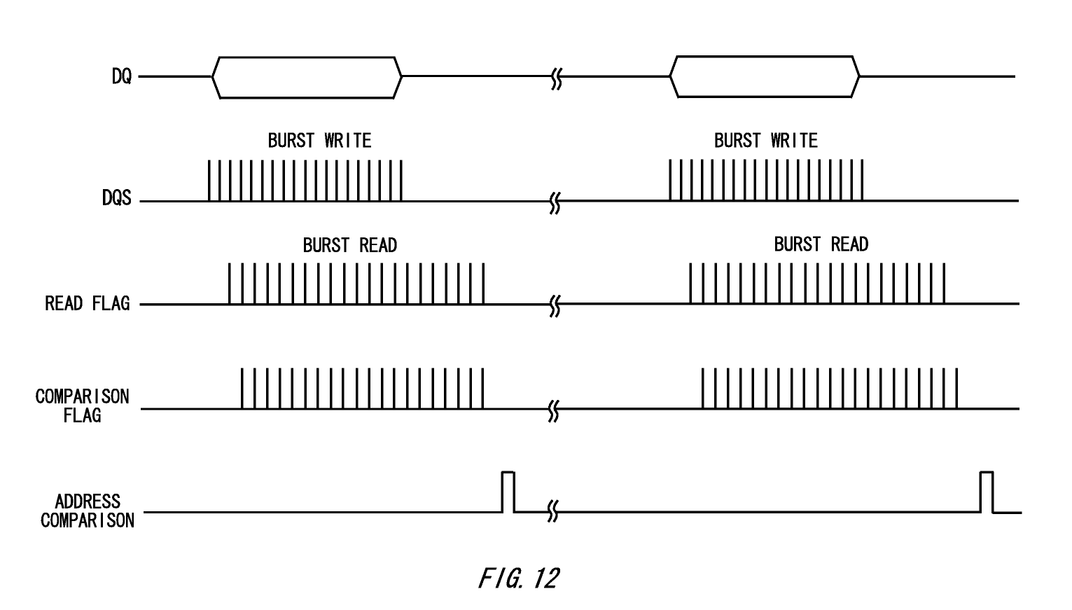

FIG. 12 shows exemplary timings of a data signal DQ, clock signal DQS, read flag, comparison flag, and address comparison in the test apparatus 10 of the present modification. Upon receiving a read command, the device under test 200 reads in series the number of pieces of data indicated by the read command.

Accordingly, when the data signal DQ output from the device under test 200 is acquired at the timing of the clock signal DQS output from the device under test 200, the buffer section 58 receives the plurality of data signals output in series from the device under test 200 and burst-writes the data signals therein. Furthermore, the reading control section 40 burst-reads the series of data signals burst-written by the buffer section 58, in series over a plurality of test periods. The judging section 42 compares the data signals read by the reading control section 40 in series over the series of test periods.

In this case, every time burst reading of the data signals by the reading control section 40 is finished, the underflow detecting section 90 compares the final write position in the buffer section 58 to the final read position, to detect whether an underflow has occurred. More specifically, every time the burst reading is finished, the underflow detecting section 90 determines that an underflow has occurred in the buffer section 58 if the final read position is positioned ahead of the final write position, i.e. if the final read position has surpassed the final wrote position.

In this way, the underflow detecting section 90 can periodically check whether an underflow has occurred during testing. Therefore, during testing, when the data signal output from the device under test 200 is not correctly written in the buffer section 58, the underflow detecting section 90 can interrupt the testing.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A test apparatus that tests a device under test outputting a data signal and a clock signal indicating a timing at which the data signal is to be sampled, the test apparatus comprising:
a buffer section that buffers the data signal;
a pattern generating section that, for each test period of the test apparatus, generates a control signal and an expected value of the data signal;
a reading control section that, for each test period, reads the data signal from the buffer section on a condition that the control signal instructs the reading control section to read data from the buffer section; and
a judging section that compares the data signal read by the reading control section to the expected value generated by the pattern generating section.

2. The test apparatus according to claim 1, wherein
for each test period, the pattern generating section generates, as the control signal, a read flag indicating whether the data signal is to be read from the buffer section and a comparison flag indicating whether the judging section is to compare the data signal and the expected value,
for each test period, the reading control section reads the data signal from the buffer section on a condition that the read flag instructs the reading control section to read the data signal, and
for each test period, the judging section compares the data signal read by the reading control section to the expected value on a condition that the comparison flag instructs the judging section to compare the data signal to the expected value.

3. The test apparatus according to claim 2, further comprising a pattern memory that stores a read flag and a comparison flag in association with each of a plurality of test instructions to be executed by the pattern generating section in respective test periods, wherein
for each test period, the pattern generating section generates an expected value by executing a test instruction stored in the pattern memory and generates the read flag and the comparison flag corresponding to the executed test instruction.

4. The test apparatus according to claim 1, wherein
the reading control section reads the data signal from the buffer section in an order in which the data signal was written to the buffer section, and
the test apparatus further comprises an underflow detecting section that detects whether a read position at which the reading control section reads the data signal from the buffer section is ahead of a write position at which the data signal is written to the buffer section.

5. The test apparatus according to claim 4, wherein
the buffer section receives a plurality of data signals output in series from the device under test, and burst-writes the received data signals,
the reading control section burst-reads the series of data signals burst-written by the buffer section, over a series of test periods, and
every time the burst reading of the data signal by the reading control section ends, the underflow detecting section compares a final write position to a final read position in the buffer section to detect an underflow.

6. The test apparatus according to claim 1, further comprising a designating section that designates whether the data signal is acquired at a timing corresponding to the clock signal or at a timing of a timing signal corresponding to the test period, wherein
the buffer section acquires the data signal at the timing corresponding to the clock signal when the designating section designates that the data signal is to be acquired at the timing of the clock signal, and acquires the data signal at the timing corresponding to the timing signal when the designating section designates that the data signal is to be acquired at the timing of the timing signal, and
for each test period, the reading control section reads the data signal from the buffer section.

7. The test apparatus according to claim 1, wherein
the test apparatus exchanges the data signal and clock signal with the device under test via a bidirectional bus.

8. The test apparatus according to claim 1, wherein
the device under test is a memory device that exchanges the data signal and the clock signal via a bidirectional bus.

9. A test method performed by a test apparatus that tests a device under test outputting a data signal and a clock signal indicating a timing at which the data signal is to be sampled, wherein the test apparatus comprises:
a buffer section that buffers the data signal acquired at the timing of the clock signal; and
a pattern generating section that, for each test period of the test apparatus, generates a control signal and an expected value of the data signal, the test method comprising:
for each test period, reading the data signal from the buffer section on a condition that the control signal instructs reading of data from the buffer section; and
comparing the read data signal to the expected value generated by the pattern generating section.
